(19) United States
(12) Patent Application Publication
(10) Pub. No.: US 2022/0338211 A1
(43) Pub. Date: Oct. 20, 2022

(54) Medium Access Control-Control Element Handling in Multi-Priority Traffic Environments

(71) Applicant: Telefonaktiebolaget LM Ericsson (PUBL), Stockholm (SE)

(72) Inventors: Abdulrahman Alabbasi, KISTA (SE); Zhenhua Zou, SOLNA (SE); Torsten Dudda, WASSENBERG (DE); John Walter Diachina, GARNER, NC (US); Henrik Enbuske, STOCKHOLM (SE)

(21) Appl. No.: 17/765,488

(22) PCT Filed: Oct. 5, 2020
(86) PCT No.: PCT/SE2020/050941

§ 371 Date: Mar. 31, 2022

Related U.S. Application Data
(60) Provisional application No. 62/910,015, filed on Oct. 3, 2019.

(51) Int. Cl. H04W 72/12; H04W 72/14

(52) U.S. Cl. CPC H04W 72/1242; H04W 72/14

(57) ABSTRACT

A method by a wireless device includes receiving a new grant for sending information. The new grant is associated with at least one transmission resource overlapping with at least one resource of a previous grant. The wireless device determines a highest priority between a priority of the new grant and a priority of the previous grant. The priority of the new grant is determined based on at least one of: one or more logical channels (LCHs) associated with the new grant and one or more medium access control-control element (MAC CEs,) mapped into the new grant. The priority of the previous grant is determined based on at least one of: one or more LCHs mapped into the previous grant and one or more MAC CEs mapped into the previous grant. The wireless device determines to use the at least one transmission resource for the one of the new grant and the previous grant having the highest priority.

### TECHNICAL FIELD

The present disclosure relates, in general, to wireless communications and, more particularly, systems and methods for Medium Access Control (MAC) Control Element (CE) handling in multi-priority traffic environments.

### BACKGROUND

The present disclosure is described within the context of 3^{rd} Generation Partnership Project (3GPP) New Radio (NR) radio technology (including within the context of 3GPP Technical Standard (TS) 38.300 V15.2.0 (2018-June)). The problems and solutions described herein are equally applicable to wireless access networks and wireless devices (e.g., user equipments (UEs)) implementing other access technologies and standards. NR is used as an example technology where the techniques described herein are suitable, and using NR in the description therefore is particularly useful for understanding the problem and solutions addressing the problem. In particular, the disclosed techniques may be applicable also to 3GPP Long Term Evolution (LTE), or 3GPP LTE and NR integration, also denoted as non-standalone NR.

In a defined 3GPP work item (RP-190728, New WID: Support of NR Industrial Internet of Things (IoT)), NR technology enhancements are studied with the target of providing more deterministic low-latency delivery of data. This traffic is also referred to as time sensitive networking (TSN) traffic with typically periodic packet occurrences per cycle time.

Uplink (UL) traffic can be scheduled with dynamic UL grants or configured UL grants. In case of dynamic grants, a NR network node (e.g., a next generation NodeB, “gNB”) provides an UL grant to the user equipment (UE) for each UL transmission. Configured grants are pre-allocated, e.g. only provided once to the UE, and thereafter the configured UL grant is valid for usage for UL transmissions according to a configured periodicity. The UE need not transmit padding on those UL resources if no UL data is available for transmission, e.g., the UE may skip UL transmission on such grants.

A typical NR-Industrial Internet of Things (IIoT) device would handle communication for multiple service types, e.g. multiple periodic Ultra-Reliable Low-Latency Communication (URLLC)-type robot control messages (also referred to as TSN-like traffic), URLLC type of occasional alarm signals (for which periodic resources would need to be configured or relying on the UE to send scheduling requests for each occasional alarm message), occasional sensor data transmission (which may be time-critical or non-time-critical), and other enhanced or regular Mobile Broadband (eMBB/MBB) best-effort type traffic, such as occasional video transmissions or software updates. As a result, a traffic mix may be multiplexed by the UE for UL transmissions, e.g., on Medium Access Control (MAC) multiple logical channels (LCHs). Each LCH may include different priorities that may be configured. In such a mixed-traffic scenario, it is crucial to treat URLLC-type of traffic with high priority without losing spectral efficiency or system capacity.

The prioritization at the UE, also referred to as intra-UE prioritization, has been discussed in NR IIoT Study Items (SIs) and in 3GPP Technical Report TR 38.825. As disclosed in “Resource Conflict between Configured and Dynamic Grants,” a UE receives a dynamic grant for uplink transmission and the associated Physical Uplink Shared Channel (PUSCH) of which overlaps in time with reserved uplink resources activated by either Type-1 or Type 2 configured grant. According to the priority rules defined in 3GPP Release 15 (Rel-15), the dynamic grant always overrides the configured grant in situations of resource conflict between the two grants. This may not be desirable in some cases, however, because configured grants are typically used for URLLC traffic, and problems may arise if URLLC traffic can be demoted or delayed by another dynamic grant.

As disclosed in “Resource Conflict between Control Information and Data,” a UE needs to conduct uplink transmission of control information such as a Scheduling Request (SR), Hybrid Automatic Repeat Request (HARQ) feedback, and/or Channel Status Information (CSI) associated with prioritized traffic at the same time as the on-going uplink transmission of control information for other traffic with lower priority levels. For example, the control information may be sent to reduce the resultant latency. For resource collision between an SR associated with high-priority traffic and the uplink data of lower-priority traffic, the current specifications of Rel-15 refrains from transmitting the SR by always prioritizing the uplink shared channel (UL-SCH) carrying the lower-priority traffic, which may cause a delay for the SR transmission, which may ultimately result in a failure to meet the Quality of Service (QoS) requirement of the high-priority traffic.

In both of the above scenarios, the principle concept is to compare the logical channel (LCH) priority associated with the transmission. In the scenario involving resource collision with data only, for cases when MAC prioritizes a grant, MAC prioritizes the grant on which data of the highest priority can be transmitted according to logical channel prioritization (LCP) restrictions and the priority configured for each logical channel. In the other scenario, prioritization between the SR associated with high-priority traffic and uplink data of lower-priority traffic, possible solutions include the definition of a prioritization handling rule to determine whether to transmit SR or PUSCH based on, e.g., the priority of the LCH which triggers the SR and priorities of the data to be transmitted on the PUSCH resource.

In both of the above intra-UE prioritization scenarios, when the UE MAC entity detects overlapping between a new UL grant (called ‘B’) (or a triggered SR) with an existing grant (called ‘A’), two cases are identified: 1) The MAC Physical Data Unit (PDU) of the transmission on grant ‘A’ has not been built; 2) The MAC PDU of the transmission on grant ‘A’ has already been built.

For simplicity, the first case may be referred to as “Selection,” Herein. As of Rel-15, there is only one MAC PDU generated when the dynamic grant overrides configured grant and such behaviour of generating only one MAC PDU should be kept if possible. This is possible considering the case when the MAC PDU subject to pre-emption (e.g., the new grant has higher priority) has not yet been built, when a second UL grant is received (e.g., via downlink control information (DCI)) and processed. This can happen in the case that the knowledge of overlapping grants and their respective user data is available for processing in MAC before construction of the MAC PDU is initiated (i.e., the MAC has enough time prior to transmission start to decide what data to prioritize and formulate the corresponding MAC PDU).

The second case may be referred to as “pre-emption.” Such cases may arise when the configured grants (CG) for high priority traffic have short PUSCH duration while the dynamic grant for low priority traffic has long PUSCH duration. It is likely that the high priority CG traffic arrives in the midst of the allocated PUSCH transmission of the dynamic grant. In such a case, the UE must construct the PDU for dynamic grant (DG) since it is not sure whether there will be data arrival for high priority traffic. On the other hand, when the high priority CG traffic arrives in the midst of the allocated PUSCH transmission of the DG, then the PDU has to be constructed for the configured grant to fulfil the requirement, even though the MAC PDU for the dynamic grant has already been constructed. Thus, there is a need to consider the scenario where two MAC PDUs are constructed.

There currently exist certain challenges. In a mixed service environment, the traffic requirements vary considerably. For instance, reliability targets vary from 99.9% up to 99.99999%. Additionally, latency targets may vary down to 0.5 msec. Such heterogeneous traffic requirements means that each traffic type may be mapped onto a different LCH priority, and it will impose on the network to serve it with different (UL/DL) grant characteristics for their respective traffic. However, the quality (e.g., the reliability and latency) of delivering such traffic does not depend only on its transmission, but it also depends on the transmission of its associated MAC Control Elements (CEs), including, but not limited to, the Buffer Status Report (BSR), Power Headroom Report (PHR), confirmation, etc.

As stated above, existing techniques compare the priority of the logical channel associated with the data transmission or the triggered SR. In addition, in 3GPP Technical Specification TS 38.321, it is specified that when UE begins to allocate resources in a given UL grant and build the MAC PDU, logical channels shall be prioritised in accordance with the following order (highest priority listed first):
Cell Radio Network Temporary Identifier (C-RNTI) MAC CE or data from uplink common control channel (UL-CCCH);
Configured Grant Confirmation MAC CE;
MAC CE for BSR, with exception of BSR included for padding;
Single Entry PHR MAC CE or Multiple Entry PHR MAC CE;
data from any Logical Channel, except data from the UL-CCCH;
MAC CE for Recommended bit rate query; and
MAC CE for BSR included for padding.

One problem is that the priorities of MAC CEs are not linked to the priority of the triggering LCH(s), which can create some complicated (illogical) scenarios wherein lower priority data is prioritized over higher priority MAC CE(s). Additionally, high priority MAC CEs sent on a low priority (low reliability, high latency) grant may create quality of service issues if done without compensating for reliability, i.e., without taking into account that the low priority grant might get lost or pre-empted.

One example is a later-received grant for supporting critical traffic pre-empts a MAC PDU assembled for an earlier grant with non-critical data, but the pre-empted MAC PDU also includes a critical MAC CE. In this situation, the critical traffic gets prioritized above the critical MAC CE that is part of the de-prioritized (pre-empted) MAC PDU.

### SUMMARY

Certain aspects of the present disclosure and their embodiments may provide solutions to these or other challenges. For example, certain embodiments appropriately prioritize high priority MAC CEs and prevent the above-described scenarios in which a high-priority MAC CE is pre-empted, e.g., by lower-priority LCHs.

According to certain embodiments, a method by a wireless device includes receiving a new grant for sending information. The new grant is associated with at least one transmission resource overlapping with at least one resource of a previous grant. The wireless device determines a highest priority between a priority of the new grant and a priority of the previous grant. The priority of the new grant is determined based on one or more LCHs mapped into the new grant and/or one or more MAC CEs mapped into the new grant. Likewise, the priority of the previous grant is determined based on one or more LCHs mapped into the previous grant and/or one or more MAC CEs mapped into the previous grant. The method further includes determining, by the wireless device, to use the at least one transmission resource for the one of the new grant and the previous grant having the highest priority.

According to certain embodiments, a wireless device includes processing circuitry configured to receive a new grant for sending information. The new grant is associated with at least one transmission resource overlapping with at least one resource of a previous grant. The processing circuitry is configured to determine a highest priority between a priority of the new grant and a priority of the previous grant. The priority of the new grant is determined based on one or more LCHs mapped into the new grant and/or one or more MAC CEs mapped into the new grant. Likewise, the priority of the previous grant is determined based on one or more LCHs mapped into the previous grant and/or one or more MAC CEs mapped into the previous grant. The processing circuitry is further configured to determine to use the at least one transmission resource for the one of the new grant and the previous grant having the highest priority.

According to certain embodiments, a method by a network node includes signalling prioritization information to a wireless device. The prioritization information indicates a highest priority between a priority of a new grant and a priority of a previous grant. The new grant and the previous grant are associated with at least one overlapping transmission resource. The priority of the new grant is based on one or more LCHs mapped into the new grant and/or one or more MAC CEs mapped into the new grant. The priority of the previous grant is based on one or more LCHs mapped into the previous grant and/or one or more MAC CEs mapped into the previous grant. The method further includes receiving, by the network node, in the at least one overlapping transmission resource, a transmission associated with the highest priority of the new grant or the previous grant based on the prioritization information signalled to the wireless device.

According to certain embodiments, a network node includes processing circuitry configured to signal prioritization information to a wireless device. The prioritization information indicates a highest priority between a priority of a new grant and a priority of a previous grant. The new grant and the previous grant are associated with at least one overlapping transmission resource. The priority of the new grant is based on one or more LCHs mapped into the new grant and/or one or more MAC CEs associated with the new grant. The priority of the previous grant is based on one or more LCHs mapped into the previous grant and/or one or more MAC CEs associated with the previous grant. The processing circuitry is further configured to receive, by the network node, in the at least one overlapping transmission resource, a transmission associated with the highest priority of the new grant or the previous grant based on the prioritization information signalled to the wireless device.

According to certain embodiments, a method by a wireless device includes determining that at least one transmission resource associated with a scheduling request overlaps with at least one resource of a previous grant and determining a highest priority between a priority of the scheduling request and a priority of the previous grant. The priority of the scheduling request is determined based on one or more LCHs triggering the scheduling request. The priority of the previous grant is determined based on one or more LCHs mapped into the previous grant and/or one or more MAC CEs mapped into the previous grant. The method further includes determining, by the wireless device, to use the at least one transmission resource for the one of the scheduling request and the previous grant having the highest priority.

According to certain embodiments, a wireless device includes processing circuitry configured to determine that at least one transmission resource associated with a scheduling request overlaps with at least one resource of a previous grant and determining a highest priority between a priority of the scheduling request and a priority of the previous grant. The priority of the scheduling request is determined based on one or more LCHs triggering the scheduling request. The priority of the previous grant is determined based on one or more LCHs mapped into the previous grant and/or one or more MAC CEs mapped into the previous grant. The processing circuitry is further configured to determine by the wireless device, to use the at least one transmission resource for the one of the scheduling request and the previous grant having the highest priority.

According to certain embodiments, a method by a network node includes signalling prioritization information to a wireless device. The prioritization information indicates a highest priority between a priority of a scheduling request and a priority of a previous grant. The scheduling request and the previous grant are associated with at least one overlapping transmission resource. The priority of the scheduling request is based on one or more LCHs triggering the scheduling request. The priority of the previous grant is based on one or more LCHs mapped into the previous grant and/or one or more MAC CEs mapped into the previous grant. The method further includes receiving, by the network node, in the at least one overlapping transmission resource, a transmission associated with the highest priority of the scheduling request or the previous grant based on the prioritization information signalled to the wireless device.

Certain embodiments may provide one or more of the following technical advantages. For example, certain embodiments maintain the appropriate prioritization of data and other signalling while maintaining the transmission of critical data according to their quality of service requirements. Indeed, certain embodiments may prevent the violation of the prioritization of logical channels as specified in relevant standards such as, for example, according to the priority list in 3GPP Technical Specification TS 38.321 section 5.4.3.1.3, which is discussed above.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example wireless network, according to certain embodiments;

FIG. 2 illustrates an example network node, according to certain embodiments;

FIG. 3 illustrates an example wireless device, according to certain embodiments;

FIG. 4 illustrate an example user equipment, according to certain embodiments;

FIG. 5 illustrates a virtualization environment in which functions implemented by some embodiments may be virtualized, according to certain embodiments;

FIG. 6 illustrates a telecommunication network connected via an intermediate network to a host computer, according to certain embodiments;

FIG. 7 illustrates a generalized block diagram of a host computer communicating via a base station with a user equipment over a partially wireless connection, according to certain embodiments;

FIG. 8 illustrates a method implemented in a communication system, according to one embodiment;

FIG. 9 illustrates another method implemented in a communication system, according to one embodiment;

FIG. 10 illustrates another method implemented in a communication system, according to one embodiment;

FIG. 11 illustrates another method implemented in a communication system, according to one embodiment;

FIG. 12 illustrates an example method by a wireless device, according to certain embodiments;

FIG. 13 illustrates another example method by a wireless device, according to certain embodiments;

FIG. 14 illustrates an example virtual computing device, according to certain embodiments;

FIG. 15 illustrates an example method by a network node, according to certain embodiments;

FIG. 16 illustrates another example virtual computing device, according to certain embodiments;

FIG. 17 illustrates another example method by a wireless device, according to certain embodiments;

FIG. 18 illustrates another example virtual computing device, according to certain embodiments;

FIG. 19 illustrates another example method by a network node, according to certain embodiments; and

FIG. 20 illustrates another example virtual computing device, according to certain embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

There are, proposed herein, various embodiments which address one or more of the issues disclosed herein. According to one embodiment, a wireless device receives a new grant or determines to send control information using resources that overlap with resources of a previous grant. The wireless device may prioritize between the new grant/control information and the previous grant by considering the priorities of both the logical channels and the MAC control elements of the grants/control information. As a result, the wireless device may consider the priority of MAC CEs when determining the priority of grants or control information in mixed-type traffic situations. As another example, the network may signal to the wireless device prioritization information, upon which the wireless device may prioritize between the grants/control information. These embodiments and additional embodiments are described herein.

In particular certain embodiments provide improved intra-UE prioritization techniques for handling MAC CEs in overlapping grant or request situations. According to a first set of embodiments, during the selection or pre-emption process, anew grant's priority used for comparison is defined. In certain embodiments, the new grant priority is defined as the highest priority of the LCHs or MAC CEs mapped into (i.e. associated with) the grant. In this manner, in contrast with previous techniques, both LCH priorities and MAC CE priorities are included in the grant selection/pre-emption decision, and thus, are used to determine the grant priority. In some embodiments, the priority order of the LCHs and MAC CEs follow the rule in the list in 3GPP TS 38.321 clause 5.4.3.1.3 (as reproduced above). In some embodiments, the priority order of the LCHs and MAC CEs follow a different priority order.

According to certain embodiments, Logical Channel Prioritization (LCP) restrictions for multiplexing MAC CEs into a grant are also defined. In some embodiments, such restrictions are defined by a fixed rule in a specification or standard. For example, a specification may state that the MAC CE is always mapped into a lower priority grant or always mapped into a higher priority grant. In some embodiments, the LCP restrictions are configurable, e.g., by a rule decided by a base station (e.g., gNB) and signalled to the UE (e.g., via Radio Resource Control (RRC)). In this manner, the multiplexing of MAC CEs may be controlled, which may be used to avoid mixed priority levels within a single grant or large differences of priority levels between the multiplexed data and MAC CE.

According to a second set of embodiments, new prioritization rules may be introduced. In certain embodiments, the priority of URLLC LCHs may be defined to be higher than that of the MAC CEs (e.g., in contrast with the priority list in TS 38.321 clause 5.4.3.1.3 reproduced above). In some embodiments, additional priority values for MAC CE may also be defined. In particular embodiments, the configuration can be specified as a fixed rule in specification or standard. In particular embodiments, the configuration may be dynamically reconfigurable through RRC or a MAC CE.

In certain embodiments, the changed priority order (e.g., URLLC LCHs considered of higher priority than some MAC CEs) is only considered for the grant selection/pre-emption decision, e.g., when determining a grant priority. In some embodiments, for other decisions, such as the order of multiplexing data from MAC CEs and LCHs to a single grant, the changed priority order may not considered, e.g., the legacy priority order as currently defined is used. In this manner, the legacy behaviour may be maintained in case of single UL grant.

In certain embodiments, the UE keeps the triggered MAC CE in a buffer before HARQ, thereby avoiding roll-back issues.

According to certain embodiments, the network, e.g., a receiving network node, ignores the MAC CE on the pre-empting grant which is re-transmitted and received at the network later—if the MAC CE was previously received.

In certain embodiments, there is a timing-related information on the MAC CE. In such situations, the network may apply MAC CE at the time of the initial transmission of the pre-empted grant, but not the initial transmission of the pre-empting grant. For example, if the MAC CE is PHR MAC CE triggered by path loss change, the network may infer that the PHR MAC CE is valid at the time of the transmission of the pre-empted grant, but not the pre-empting grant. In some embodiments, the UE indicates that the MAC CE is triggered and sent a number X transmissions ago, or a number Y slots ago.

In certain embodiments, the network configures a set of priorities for MAC CEs. In some embodiments, the network configures the priorities such that UE has to transmit the associated MAC CEs on only reliability grants.

According to certain other embodiments, the MAC CE is ignored in the grant prioritization rules and/or procedures. For example, if there is a MAC PDU with only MAC CEs, it will be considered as lower priority than any MAC PDU with LCH data and any MAC CE. Consequently, if there are two MAC PDUs both of which have only MAC CEs, then they are considered as equal priority. In this manner, the prioritization rules may be redefined in a stable and predictable way, thereby ensuring compliance in mixed-type traffic situations.

In certain embodiments, the priorities of the LCHs and/or MAC CEs may be based on an indication or index based on a measured or expected reliability of the grant on which the LCHs and/or MAC CEs are found. For example, the UE may decide how to construct the MAC PDU based on the grant's transmission profile indication or index (TPI), which may be defined as a value that represents the grant's reliability (and optionally, latency), e.g., as a function of the Modulation Coding Scheme (MCS), coding rate, repetition, etc. In some embodiments, the TPI may be defined to identify which LCH or MAC CE are allowed to be sent on the grant's resources.

In certain embodiments, if a MAC CE is included in a pre-empted grant, e.g., being in a grant having a lower priority than a later-received grant, the MAC CE may be included in the pre-empting grant. For example, the pre-empted MAC CE may be included in a transport block of the pre-empting grant (e.g., multiplexed as part of the new pre-empting MAC PDU). In some embodiments, the inclusion of the pre-empted MAC CE may depend on the MAC CE type (e.g., how time-critical it is for the network to receive the MAC CE). In some embodiments, whether the pre-empted MAC CE is included in the pre-empting PDU is based on its priority. For example, a BSR MAC CE may be re-included while other types of MAC CEs would not be included (e.g., MAC CEs for confirmation, recommended bit rate query, PHR, etc.). In this manner, only the highest priority or most timely MAC CEs would be considered for inclusion in the pre-empting grant resources if they are pre-empted. In some embodiments, the inclusion of the pre-empted MAC CE(s) is based on the available space in the pre-empting MAC PDU, whereby the MAC CE may not be included if there is not sufficient space in the transport block and vice versa. Further, in certain embodiments, the UE may signal to the receiving network node that the MAC PDU/transport block has been pre-empted, so that it knows that communicated MAC CEs may not match the expected LCHs, but may be valid for later-transmitted LCHs or vice versa.

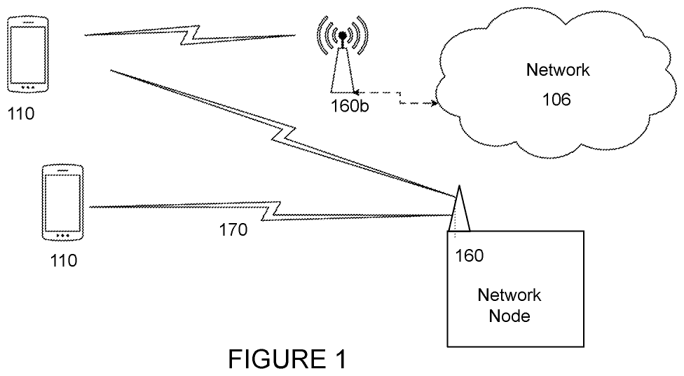

Although the subject matter described herein may be implemented in any appropriate type of system using any suitable components, the embodiments disclosed herein are described in relation to a wireless network. FIG. 1 illustrates an example wireless network, according to certain embodiments. For simplicity, the wireless network of FIG. 1 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

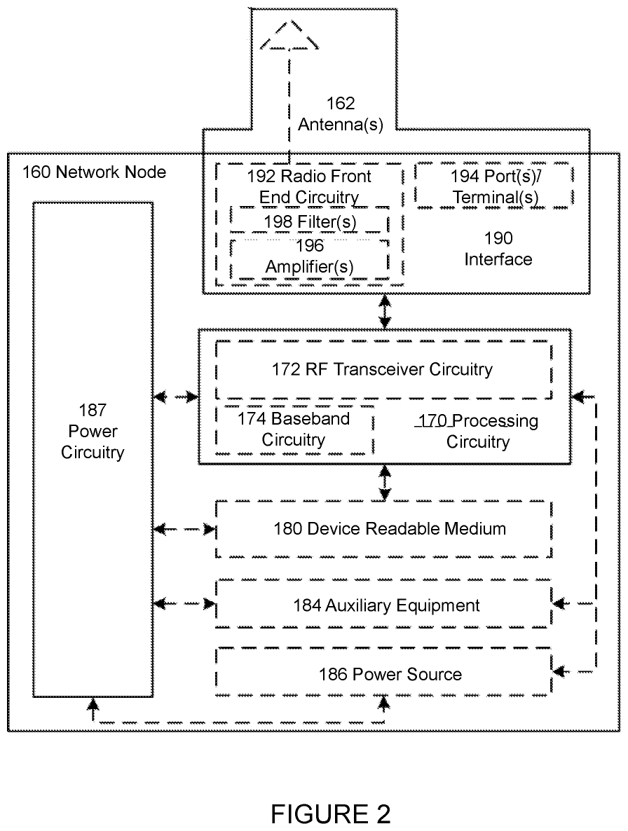

FIG. 2 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., Mobile Switching Centers (MSCs), Mobility Management Entity (MMEs)), Operations & Maintenance (O&M) nodes, Operations Support System (OSS) nodes, Self-Optimizing Network (SON) nodes, positioning nodes (e.g., Evolved-Serving Mobile Location Centre (E-SMLCs)), and/or Minimization of Drive Tests (MDTs). As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 2, network node 160 includes processing circuitry 170, device readable medium 180, interface 190, auxiliary equipment 184, power source 186, power circuitry 187, and antenna 162. Although network node 160 illustrated in the example wireless network of FIG. 1 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, Global System for Mobile Communications (GSM), Wide Code Division Multiplexing Access (WCDMA), Long Term Evolution (LTE), New Radio (NR), WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 2 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

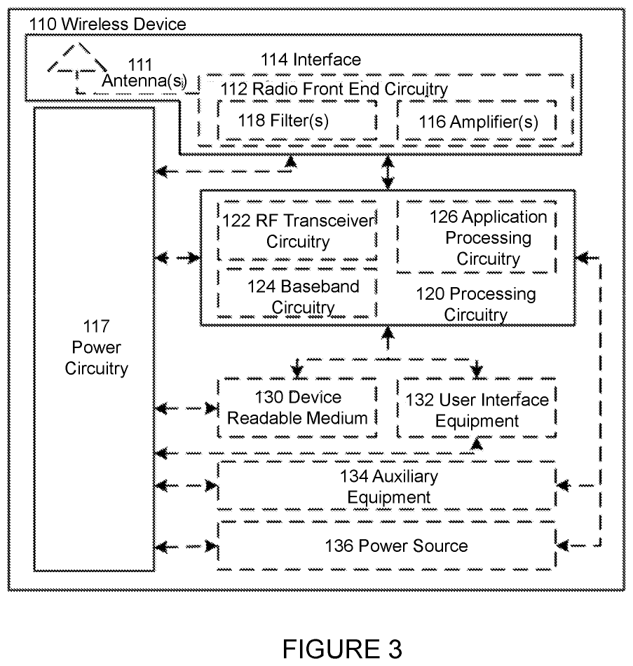

FIG. 3 illustrates an example wireless device (WD) 110, according to certain embodiments. As used herein, WD refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

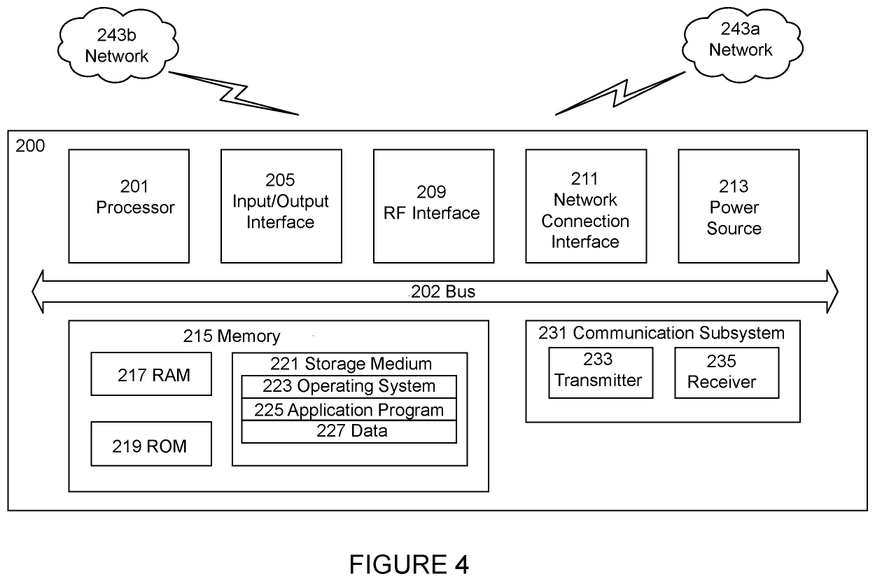

FIG. 4 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 2, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 4 is a UE, the components discussed herein are equally applicable to a WD, and vice-versa.

In FIG. 4, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 2, or only a subset of the components. The level of integration between the components may vary from one UE to another UE. Further, certain UEs may contain multiple instances of a component, such as multiple processors, memories, transceivers, transmitters, receivers, etc.

In FIG. 4, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 4, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 4, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

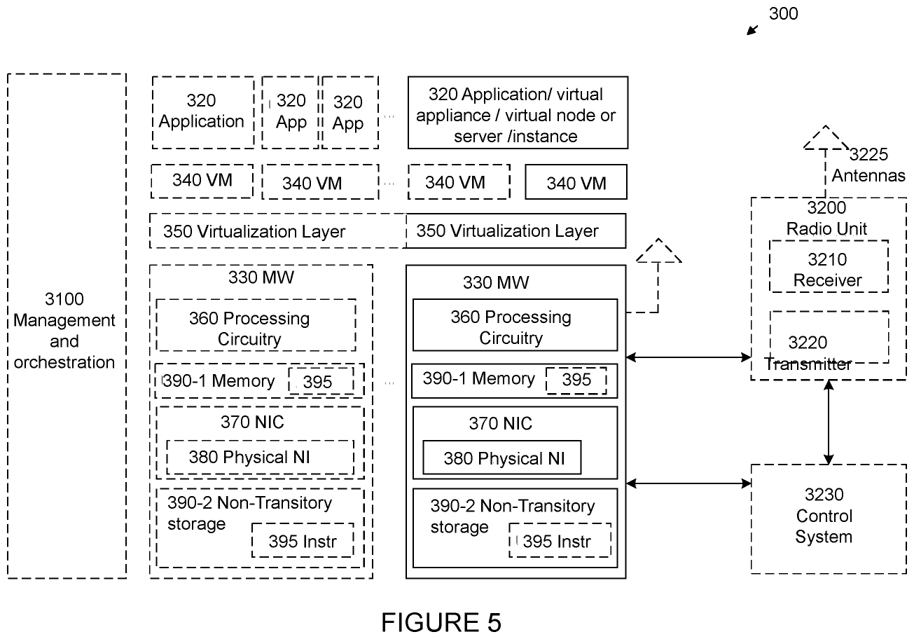

FIG. 5 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 5, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 5.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

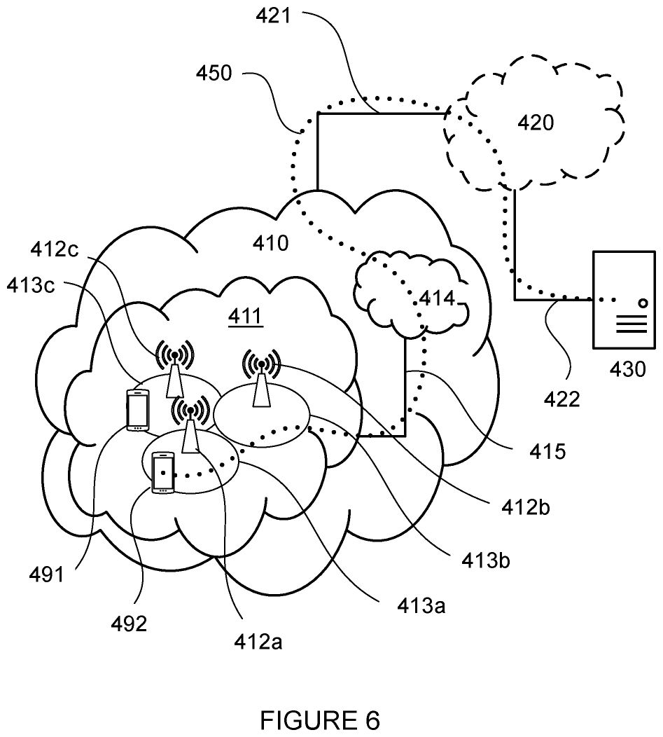

With reference to FIG. 6, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 6 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

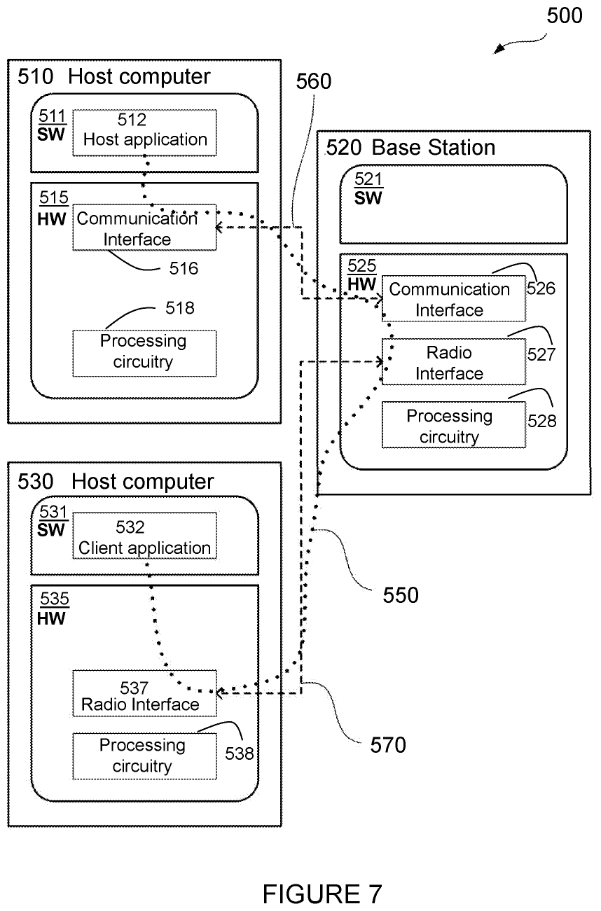

Example implementations, in accordance with an embodiment, of the UE, base station and host computer discussed in the preceding paragraphs will now be described with reference to FIG. 7. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 5) served by base station 520. Communication interface 526 may be configured to facilitate connection 560 to host computer 510. Connection 560 may be direct or it may pass through a core network (not shown in FIG. 5) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 5 may be similar or identical to host computer 430, one of base stations 412a, 412b, 412c and one of UEs 491, 492 of FIG. 4, respectively. This is to say, the inner workings of these entities may be as shown in FIG. 5 and independently, the surrounding network topology may be that of FIG. 4.

In FIG. 7, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate and latency and thereby provide benefits such as reduced user waiting time, better responsiveness, and adherence to quality of service requirements.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

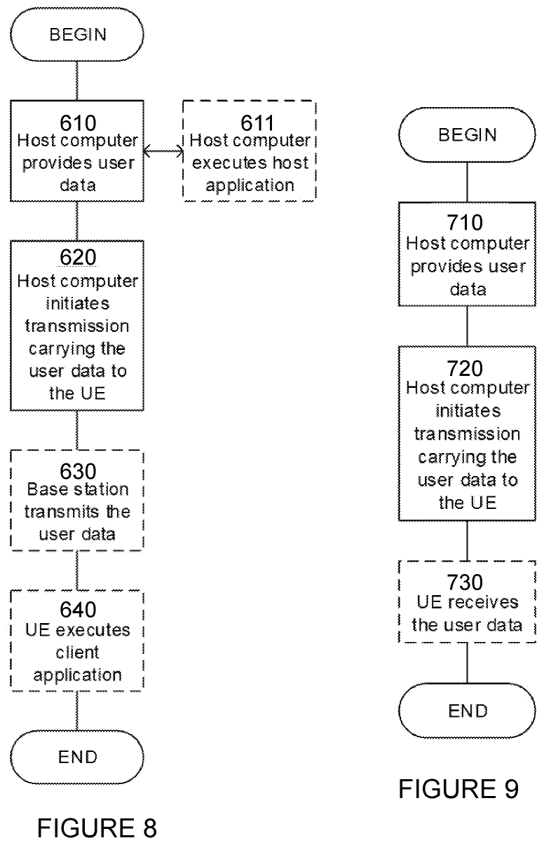

FIG. 8 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 6 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 9 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 9 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

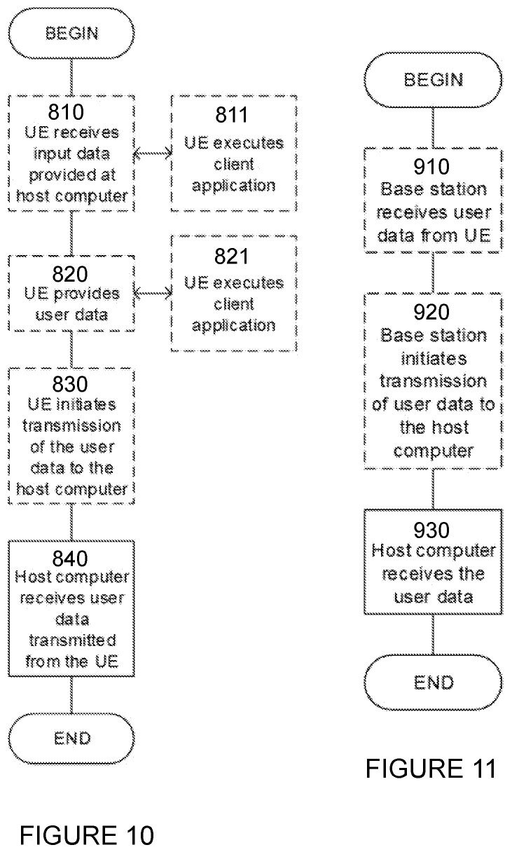

FIG. 10 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 10 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 11 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 11 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

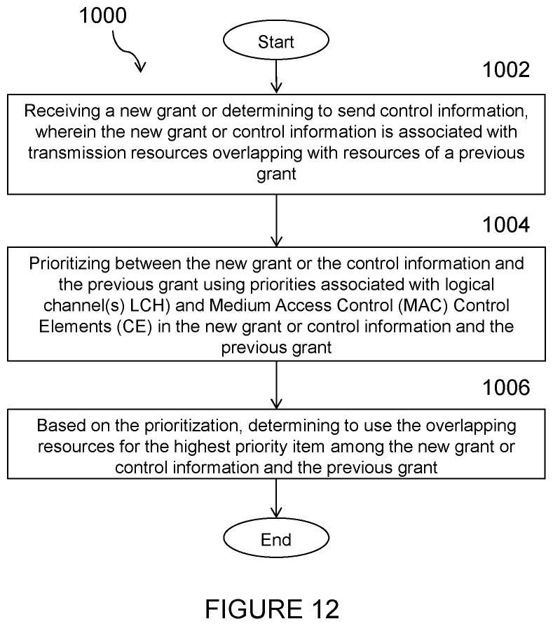

FIG. 12 depicts a method in accordance with particular embodiments, the method begins at step 1002 with receiving a new grant or determining to send control information. For example, a wireless device may receive a new grant, e.g., a dynamic grant or determine to send control information such as a scheduling request. In some cases, the new grant or control information is associated with transmission resources overlapping with resources of a previous grant. As a result, a wireless device, such as a UE, has to determine which of the grants or between the control information and the previous grant is to use the resources.

At step 1004, the new grant or the control information and the previous grant are prioritized using priorities associated with both the logical channel(s) (LCH) and the medium access control (MAC) control element(s) (CE) in the new grant or control information and the previous grant. For example, in certain embodiments, the priority of the new grant or control information is the highest priority among the priorities of its constituent LCHs and MAC CEs. Similarly, in certain embodiments, the priority of the previous grant is the highest priority among the priorities of its constituent LCHs and MAC CEs. In these embodiments, the two determine priorities which are the highest priority of their constituent LCHs and MAC CEs are compared to determine which to prioritize over the other in the same overlapping resources.

At step 1006, the overlapping resources are determined to be used for the highest priority item among the new grant or control information and the previous grant, e.g., based on the prioritization of step 1004. For example, a wireless device may determine to construct a physical data unit (PDU) for only one of the new grant/control information and the previous grant based on which has the highest priority. As another example, if the PDU for the previous grant has already been constructed, but the new grant or control information is determined to have a higher priority than the previous grant, a second PDU for the new grant or control information is to be constructed. The PDU of the previous grant may be discarded or moved for later use. In this manner, the method depicted in FIG. 10 may allow a wireless device, e.g., a UE, to conduct intra-UE prioritization that is consistent and gives proper consideration to the priority of MAC CEs.

In certain embodiments, the method depicted in FIG. 12 may include additional and/or optional steps. For example, the method may include one or more additional or optional steps to carry out one or more of the functions of the UE prioritization techniques described herein. Additional method(s) are also contemplated in reference to the network and nodes thereof to carry out one or more functions described herein.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In some embodiments a computer program, computer program product or computer readable storage medium comprises instructions which when executed on a computer perform any of the embodiments disclosed herein. In further examples the instructions are carried on a signal or carrier and which are executable on a computer wherein when executed perform any of the embodiments disclosed herein.

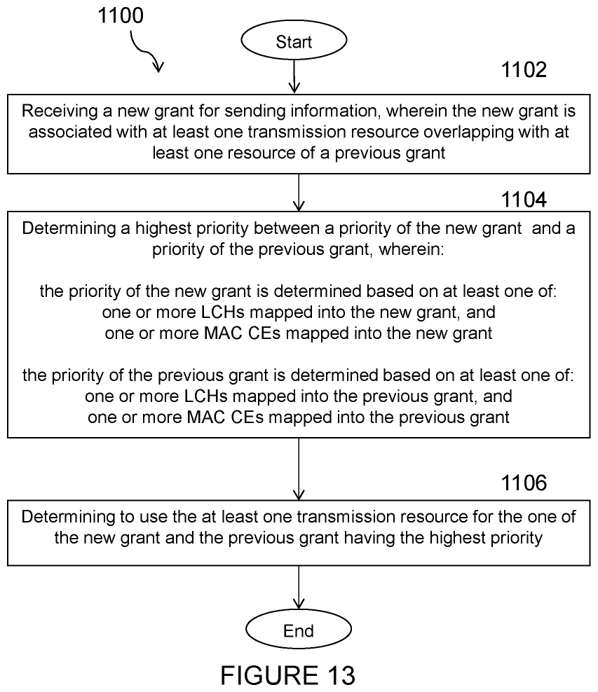

FIG. 13 illustrates an exemplary method 1100 by a wireless device 110, according to certain embodiments. The method begins at step 1102 when wireless device 110 receives a new grant for sending information. The new grant is associated with at least one transmission resource overlapping with at least one resource of a previous grant. At step 1104, the wireless device determines a highest priority between a priority of the new grant and a priority of the previous grant. The priority of the new grant is determined based on one or more LCHs mapped into the new grant and/or one or more MAC CEs mapped into the new grant. The priority of the previous grant is determined based on one or more LCHs mapped into the previous grant and/or one or more MAC CEs mapped into the previous grant. At step 1106, the wireless device 110 determines to use the at least one transmission resource for the one of the new grant and the previous grant having the highest priority.

In a particular embodiment, the new grant is a configured grant or a dynamic grant and the previous grant is a configured grant or a dynamic grant.

In a particular embodiment, the information associated with the new grant comprises control information associated with prioritized traffic, the previous grant is used for an on-going uplink transmission using the UL-SCH, and the at least one transmission resource is determined to be used for sending the prioritized traffic and control information associated with the new grant.

In a particular embodiment, the previous grant is for sending control information.

In a particular embodiment, the priority of the previous and new grants are determined based on the respective priority of the information associated with each of the grants.

In a particular embodiment, the highest priority of the one or more LCHs and one or more MAC CEs mapped into the new grant or the previous grant is determined as follows with highest to lowest priorities listed in descending order: C-RNTI, MAC CE, or data from UL-CCCH; Configured Grant Confirmation MAC CE; MAC CE for BSR, with exception of BSR included for padding; Single Entry PHR, MAC CE or Multiple Entry PHR MAC CE; data from any Logical Channel, except data from the UL-CCCH; MAC CE for Recommended bit rate query; and MAC CE for BSR included for padding.

In a particular embodiment, the highest priority of the one or more LCHs and one or more MAC CEs mapped into the new grant or the previous grant is determined based on signalling received from a network node.

In a particular embodiment, any grant for which only one or more MAC CEs are available for transmission will be considered as having lower priority than any grant for which traffic and any number of MAC CEs are available for transmission when determining the priority of the new grant and the priority the previous grant.

In a particular embodiment, any MAC CEs are assigned a lower priority than any LCHs for which traffic is available when determining the priority of the new grant and the priority of the previous grant.

In a particular embodiment, wireless device 110 determines to multiplex a MAC CE into the transmission made for the new grant or the previous grant based on a predetermined rule. The predetermined rule is based on a standard or signalled to the wireless device. The wireless device 110 multiplexes the MAC CE into the new grant or the previous grant based on the predetermined rule.

In a further particular embodiment, the predetermined rule specifies whether any given MAC CE associated with either the new grant or previous grant is to be multiplexed into the transmission made for the one of the previous grant and the new grant that is of a lower priority.

In a further particular embodiment, the predetermined rule specifies whether any given MAC CE associated with either the new grant or previous grant is to be multiplexed into the one of the previous grant and the new grant that is of the higher priority.

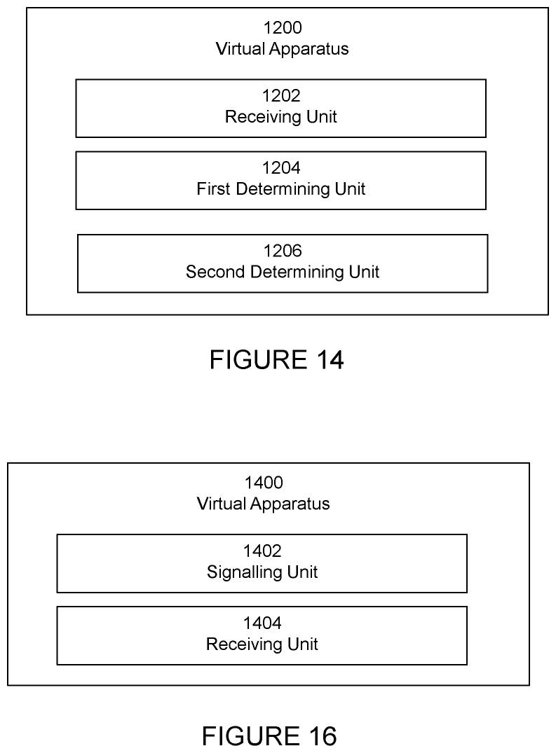

In certain embodiments, the method as described above may be performed by a computer networking virtual apparatus. FIG. 14 illustrates an example virtual computing device 1200, according to certain embodiments. In certain embodiments, virtual computing device 1200 may include modules for performing steps similar to those described above with regard to the method illustrated and described in FIG. 13. For example, virtual computing device 1200 may include a receiving unit 1202, a first determining unit 1202, a second determining unit 1206, and any other suitable units or modules. In some embodiments, one or more of the units or modules may be implemented using one or more processors 120 of FIG. 3. In certain embodiments, the functions of two or more of the various units or modules may be combined into a single unit or module.

The receiving unit 1202 may perform the receiving functions of virtual computing device 1200. For example, in a particular embodiment, receiving unit 1202 may receive a new grant for sending information. The new grant is associated with at least one transmission resource overlapping with at least one resource of a previous grant.

The first determining unit 1204 may perform certain of the determining functions of virtual computing device 1200. For example, in a particular embodiment, first determining unit 1204 may determine a highest priority between a priority of the new grant and a priority of the previous grant. The priority of the new grant is determined based on one or more LCHs mapped into the new grant and/or one or more MAC CEs mapped into the new grant. The priority of the previous grant is determined based on one or more LCHs mapped into the previous grant and/or one or more MAC CEs mapped into the previous grant.

The second determining unit 1206 may perform the determining functions of virtual computing device 1200. For example, in a particular embodiment, second determining unit 1206 may determine to use the at least one transmission resource for the one of the new grant and the previous grant having the highest priority.

Other embodiments of virtual computing device 1200 may include additional components beyond those shown in FIG. 14 that may be responsible for providing certain aspects of the wireless device's functionality, including any of the functionality described above and/or any additional functionality (including any functionality necessary to support the solutions described above). The various different types of wireless devices 110 may include components having the same physical hardware but configured (e.g., via programming) to support different radio access technologies, or may represent partly or entirely different physical components.

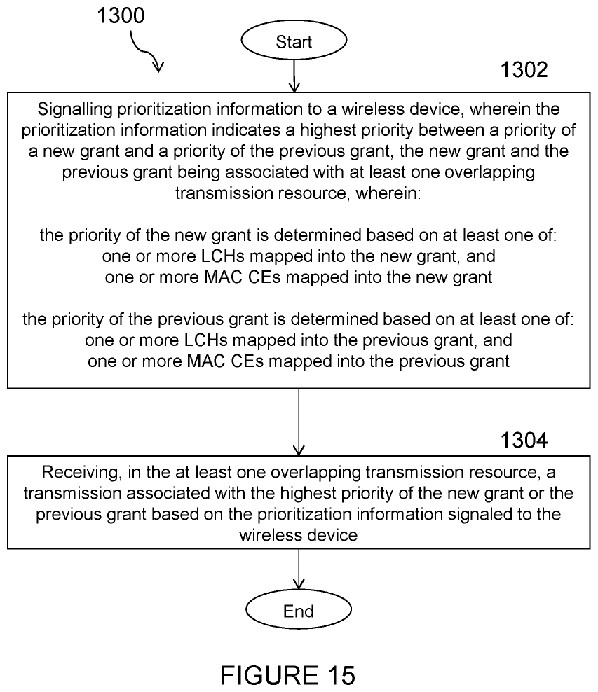

FIG. 15 illustrates an exemplary method 1300 by a network node 160, according to certain embodiments. The method begins at step 1302 when network node 160 signals prioritization information to a wireless device 110. The prioritization information indicates a highest priority between a priority of a new grant and a priority of a previous grant. The new grant and the previous grant are associated with at least one overlapping transmission resource. The priority of the new grant is based on one or more LCHs mapped into the new grant and/or one or more MAC CEs mapped into the new grant. The priority of the previous grant is based on one or more LCHs mapped into the previous grant and/or one or more MAC CEs mapped into the previous grant. At step 1304, the network node 160 receives, in the at least one overlapping transmission resource, a transmission associated with the highest priority of the new grant or the previous grant based on the prioritization information signalled to the wireless device 110.

In a particular embodiment, the new grant is a configured grant or a dynamic grant and the previous grant is a configured grant or a dynamic grant.

In a particular embodiment, the information associated with the new grant comprises control information associated with prioritized traffic, and the previous grant is used for an on-going uplink transmission using the uplink shared channel, UL-SCH. The at least one overlapping transmission resource is used for sending the prioritized traffic and control information associated with the new grant.

In a particular embodiment, the previous grant is for sending control information associated with prioritized traffic, and the at least one overlapping transmission resource is used for sending the prioritized traffic and the control information associated with the previous grant.

In a particular embodiment, the new grant is a dynamic grant and the previous grant is a configured grant used for Ultra-Reliable Low-Latency Communication, URLLC, type traffic. The highest priority of the new grant and the previous grant is the previous grant, and the at least one overlapping transmission resource is used for the URLLC type traffic.

In a particular embodiment, signalling the prioritization information to the wireless device includes dynamically configuring a respective priority to apply to each one of a plurality of LCHs and MAC CEs.

In a particular embodiment, the prioritization information indicates that a priority of any MAC CEs is lower than a priority of any LCHs.

In a particular embodiment, the prioritization information indicates a priority of the information associated with each of the respective grants.

In a particular embodiment, the method further includes signalling, to the wireless device 110, logical channel prioritization restrictions for multiplexing at least one MAC CE into a transmission made for the new grant or the previous grant.

In a particular embodiment, the method further includes ignoring a MAC CE in a later transmission if the MAC CE was included in the transmission associated with the highest priority of the new grant or the previous grant.

In a particular embodiment, the method further includes receiving a transmission comprising a MAC CE, wherein the MAC CE includes timing-related information and determining the validity time of the MAC CE timing-related information.

In a further particular embodiment, the method includes receiving an indication from the wireless device 110 that the MAC CE including timing-related information was included in a previous transmission. In a further particular embodiment, the indication indicates that the MAC CE was triggered and sent a number X transmissions prior to the transmission associated with the highest priority of the new grant or the previous grant or sent a number Y slots previous to a current slot associated with the highest priority of the new grant or the previous grant.

In a particular embodiment, the method further includes configuring a set of priorities for a set of MAC CEs that limits a transmission of the set of MAC CEs to be transmitted on only a grant having a reliability that meets a threshold reliability level.

In certain embodiments, the method as described above may be performed by a computer networking virtual apparatus. FIG. 16 illustrates an example virtual computing device 1400, according to certain embodiments. In certain embodiments, virtual computing device 1400 may include modules for performing steps similar to those described above with regard to the method illustrated and described in FIG. 15. For example, virtual computing device 1400 may include a signalling unit 1402, a receiving unit 1406, and any other suitable units or modules. In some embodiments, one or more of the units or modules may be implemented using one or more processors 170 of FIG. 2. In certain embodiments, the functions of two or more of the various units or modules may be combined into a single unit or module.

The signalling unit 1402 may perform the signalling functions of virtual computing device 1400. For example, in a particular embodiment signalling unit 1402 may signal prioritization information to a wireless device 110. The prioritization information indicates a highest priority between a priority of a new grant and a priority of a previous grant. The new grant and the previous grant are associated with at least one overlapping transmission resource. The priority of the new grant is based on one or more LCHs mapped into the new grant and/or one or more MAC CEs mapped into the new grant. The priority of the previous grant is based on one or more LCHs mapped into the previous grant and/or one or more MAC CEs mapped into the previous grant.

The receiving unit 1404 may perform the receiving functions of virtual computing device 1400. For example, in a particular embodiment, receiving unit 1404 may receive, in the at least one overlapping transmission resource, a transmission associated with the highest priority of the new grant or the previous grant based on the prioritization information signalled to the wireless device.

Other embodiments of virtual computing device 1400 may include additional components beyond those shown in FIG. 16 that may be responsible for providing certain aspects of the network node's functionality, including any of the functionality described above and/or any additional functionality (including any functionality necessary to support the solutions described above). The various different types of network nodes 115 may include components having the same physical hardware but configured (e.g., via programming) to support different radio access technologies, or may represent partly or entirely different physical components.

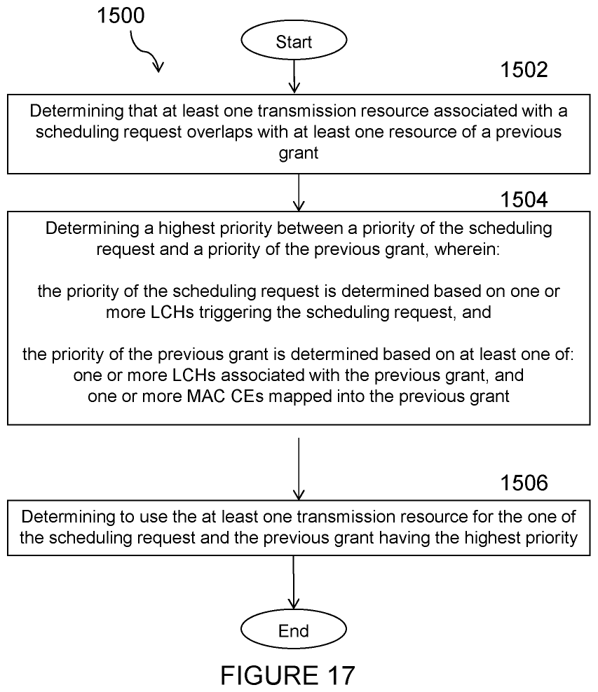

FIG. 17 illustrates another exemplary method 1500 by a wireless device 110, according to certain embodiments. The method begins at step 1502 when wireless device 110 determines that at least one transmission resource associated with a scheduling request overlaps with at least one resource of a previous grant. At step 1504, the wireless device 110 determines a highest priority between a priority of the scheduling request and a priority of the previous grant. The priority of the scheduling request is determined based on one or more LCHs triggering the scheduling request. The priority of the previous grant is determined based on one or more LCHs mapped into the previous grant and/or one or more MAC CEs mapped into the previous grant. At step 1506, the wireless device 110 determines to use the at least one transmission resource for the one of the scheduling request and the previous grant having the highest priority.

In a particular embodiment, the highest priority between the priority of the scheduling request and the priority of the previous grant is determined based on a prioritization handling rule.

In a particular embodiment, the wireless device 110 receives the prioritization handling rule from a network node 160.

In a particular embodiment, the scheduling request is associated with high-priority information. The previous grant is associated with low-priority information, and the scheduling request is determined to be the highest priority. As such, determining to use the at least one transmission resource for the one of the scheduling request and the previous grant comprises determining to use the at least one transmission resource for the scheduling request.

In a particular embodiment, the scheduling request is associated with low-priority information, and the previous grant is associated with high-priority information. The previous grant is determined to be the highest priority. As such, determining to use the at least one transmission resource for the one of the scheduling request and the previous grant comprises determining to use the at least one transmission resource for the previous grant.

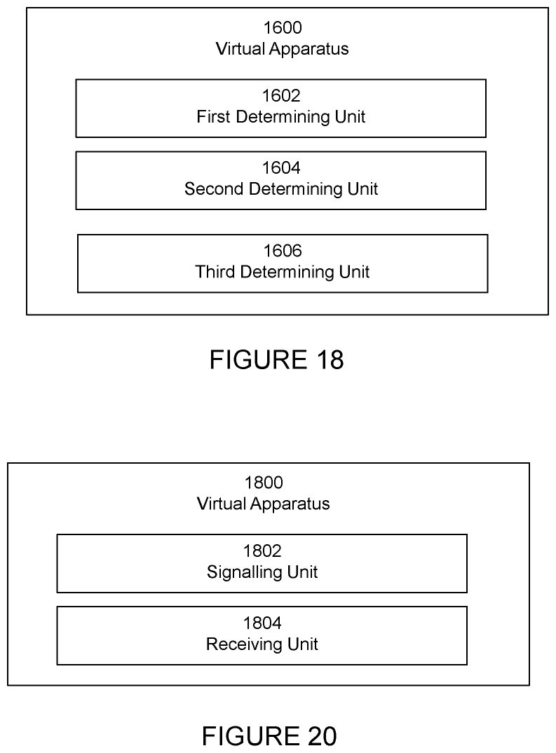

In certain embodiments, the method as described above may be performed by a computer networking virtual apparatus. FIG. 18 illustrates an example virtual computing device 1600, according to certain embodiments. In certain embodiments, virtual computing device 1600 may include modules for performing steps similar to those described above with regard to the method illustrated and described in FIG. 17. For example, virtual computing device 1600 may include a first determining unit 1602, a second determining unit 1602, a third determining unit 1606, and any other suitable units or modules. In some embodiments, one or more of the units or modules may be implemented using one or more processors 120 of FIG. 3. In certain embodiments, the functions of two or more of the various units or modules may be combined into a single unit or module.

The first determining unit 1602 may perform certain of the determining functions of virtual computing device 1600. For example, in a particular embodiment, first determining unit 1602 may determine that at least one transmission resource associated with a scheduling request overlaps with at least one resource of a previous grant.

The second determining unit 1604 may perform certain other of the determining functions of virtual computing device 1600. For example, in a particular embodiment, second determining unit 1604 may determine a highest priority between a priority of the scheduling request and a priority of the previous grant. The priority of the scheduling request is determined based on one or more LCHs triggering the scheduling request. The priority of the previous grant is determined based on one or more LCHs mapped into the previous grant and/or one or more MAC CEs associated with the previous grant.

The third determining unit 1606 may perform certain other of the determining functions of virtual computing device 1600. For example, in a particular embodiment, third determining unit 1606 may determine to use the at least one transmission resource for the one of the scheduling request and the previous grant having the highest priority.

Other embodiments of virtual computing device 1600 may include additional components beyond those shown in FIG. 18 that may be responsible for providing certain aspects of the wireless device's functionality, including any of the functionality described above and/or any additional functionality (including any functionality necessary to support the solutions described above). The various different types of wireless devices 110 may include components having the same physical hardware but configured (e.g., via programming) to support different radio access technologies, or may represent partly or entirely different physical components.

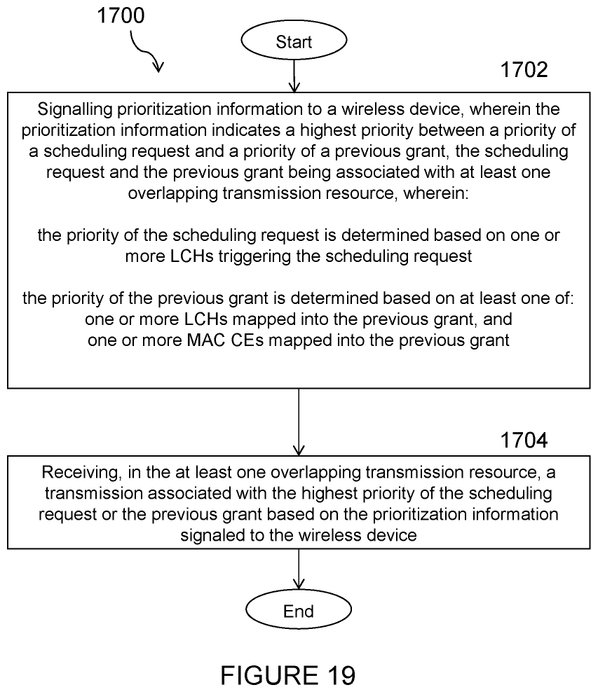

FIG. 19 illustrates another exemplary method 1700 by a network node 160, according to certain embodiments. The method begins at step 1702 when network node 160 signals prioritization information to a wireless device 110. The prioritization information indicates a highest priority between a priority of a scheduling request and a priority of a previous grant. The scheduling request and the previous grant are associated with at least one overlapping transmission resource. The priority of the scheduling request is based on one or more LCHs triggering the scheduling request. The priority of the previous grant is based on one or more LCHs mapped into the previous grant and/or one or more MAC CEs mapped into the previous grant. At step 1704, the network node 160 receives 1704, in the at least one overlapping transmission resource, a transmission associated with the highest priority of the scheduling request or the previous grant based on the prioritization information signalled to the wireless device.

In a particular embodiment, the prioritization information comprises a prioritization handling rule.

In a particular embodiment, the prioritization information indicates the respective priority of information to be transmitted based on the scheduling request and the previous grant.

In a particular embodiment, the scheduling request is associated with high-priority information and the previous grant is associated with low-priority information. As such, the scheduling request is the highest priority, and the transmission received in the at least one overlapping transmission resource is associated with the scheduling request.

In a particular embodiment, the scheduling request is associated with low-priority information, and the previous grant is associated with high-priority information. As such, the previous grant is the highest priority, and the transmission received in the at least one overlapping transmission resource is associated with the previous grant.

In certain embodiments, the method as described above may be performed by a computer networking virtual apparatus. FIG. 20 illustrates an example virtual computing device 1800, according to certain embodiments. In certain embodiments, virtual computing device 1800 may include modules for performing steps similar to those described above with regard to the method illustrated and described in FIG. 19. For example, virtual computing device 1800 may include a signalling unit 1802, a receiving unit 1806, and any other suitable units or modules. In some embodiments, one or more of the units or modules may be implemented using one or more processors 170 of FIG. 2. In certain embodiments, the functions of two or more of the various units or modules may be combined into a single unit or module.

The signalling unit 1802 may perform the signalling functions of virtual computing device 1800. For example, in a particular embodiment signalling unit 1802 may signal prioritization information to a wireless device 110. The prioritization information indicates a highest priority between a priority of a scheduling request and a priority of a previous grant. The scheduling request and the previous grant are associated with at least one overlapping transmission resource. The priority of the scheduling request is based on one or more LCHs triggering the scheduling request. The priority of the previous grant is based on one or more LCHs mapped into the previous grant and/or one or more MAC CEs mapped into the previous grant.

The receiving unit 1804 may perform the receiving functions of virtual computing device 1800. For example, in a particular embodiment, receiving unit 1804 may receive, in the at least one overlapping transmission resource, a transmission associated with the highest priority of the scheduling request or the previous grant based on the prioritization information signalled to the wireless device.

Other embodiments of virtual computing device 1800 may include additional components beyond those shown in FIG. 20 that may be responsible for providing certain aspects of the network node's functionality, including any of the functionality described above and/or any additional functionality (including any functionality necessary to support the solutions described above). The various different types of network nodes 115 may include components having the same physical hardware but configured (e.g., via programming) to support different radio access technologies, or may represent partly or entirely different physical components.

### EXAMPLE EMBODIMENTS

Example Embodiment 1. A method performed by a wireless device, the method comprising: receiving a new grant or determining to send control information, wherein the new grant or control information is associated with transmission resources overlapping with resources of a previous grant; prioritizing between the new grant or the control information and the previous grant using priorities associated with logical channel(s) (LCH) and medium access control (MAC) control element(s) (CE) in the new grant or control information and the previous grant; and based on the prioritization, determining to use the overlapping resources for the highest priority item among the new grant or control information and the previous grant.

Example Embodiment 2. The method of the previous embodiment, wherein the new grant is a dynamic grant and the previous grant is a configured grant.

Example Embodiment 3. The method of the embodiment 1, wherein the control information comprises one or more of a scheduling request, Hybrid Automatic Repeat Request (HARQ) feedback, and Channel Status Information (CSI).

Example Embodiment 4. The method of any of the previous embodiments, wherein a physical data unit (PDU) has been constructed for the previous grant before receiving the new grant or determining to send control information.

Example Embodiment 5. The method of any of embodiments 1-3, wherein a physical data unit (PDU) has not yet been constructed for the previous grant before receiving the new grant or determining to send control information.

Example Embodiment 6. The method of any of the previous embodiments, wherein prioritizing between the new grant or the control information and the previous grant comprises: determining the prioritization of the new grant or control information as the highest priority of the LCHs or MAC CEs mapped into the new grant or control information; and determining the prioritization of the previous grant as the highest priority of the LCHs or MAC CEs mapped into the new grant or control information.

Example Embodiment 7. The method of any of the previous embodiments, wherein the prioritization of the LCHs and MAC CEs is based on the following priority list with highest priority listed first: Cell Radio Network Temporary Identifier (C-RNTI) MAC CE or data from uplink common control channel (UL-CCCH); Configured Grant Confirmation MAC CE; MAC CE for Buffer Status Report (BSR), with exception of BSR included for padding; Single Entry Power Headroom Report (PHR) MAC CE or Multiple Entry PHR MAC CE; data from any Logical Channel, except data from the UL-CCCH; MAC CE for Recommended bit rate query; and MAC CE for BSR included for padding.

Example Embodiment 8. The method of any of the previous embodiments, wherein the prioritization of the LCHs and MAC CEs is predetermined based on a rule and/or standard.

Example Embodiment 9. The method of any of the previous embodiments, wherein the prioritization of the LCHs and MAC CEs is configured based on signaling in the network in which the wireless device operates.

Example Embodiment 10. The method of any of the embodiments 1-6 and 8-9, wherein the priority of Ultra-Reliable Low-Latency Communication (URLLC) LCHs are defined to be higher than the priorities of MAC CEs.

Example Embodiment 11. The method of any of the previous embodiments, wherein the priorities associated with the LCHs and MAC CEs considered for prioritization between the new grant or the control information and the previous grant is different from the priorities used for prioritization for other decisions.

Example Embodiment 12. The method of the previous embodiment, wherein the priorities used for prioritization for the other decisions are based on a legacy rule.

Example Embodiment 13. The method of any of embodiments 11-12, wherein the other decisions include a decision of the order of multiplexing data from MAC CEs and LCHs to a single grant.

Example Embodiment 14. The method of any of the previous embodiments, further comprises indicating that a MAC CE is triggered and previously sent a number of transmissions or slots prior to the current transmission or slot.

Example Embodiment 15. The method of any of the previous embodiments, wherein MAC CEs are ignored during the prioritization between the new grant or the control information and the previous grant.

Example Embodiment 16. The method of any of the previous embodiments, wherein MAC CEs are assigned a lowest priority for the prioritization between the new grant or the control information and the previous grant.

Example Embodiment 17. The method of any of the previous embodiments, further comprising: determining to multiplex a MAC CE into a grant based on a predetermined rule, wherein the predetermined rule is based on a standard or signaled to the wireless device; and multiplexing the MAC CE into the grant based on the predetermined rule.

Example Embodiment 18. The method of the previous embodiment, wherein the predetermined rule specifies that the MAC CE is to be multiplexed into a lower priority grant.

Example Embodiment 19. The method of embodiment 17, wherein the predetermined rule specifies that the MAC CE is to be multiplexed into a higher priority grant.

Example Embodiment 20. A method performed by a wireless device, the method comprising: receiving a new grant, wherein the new grant is associated with transmission resources overlapping with resources of a previous grant; prioritizing between the new grant and the previous grant using priorities associated with logical channel(s) (LCH) and medium access control (MAC) control element(s) (CE) in the new grant and the previous grant; and based on the prioritization, determining to use the overlapping resources for the highest priority item among the new grant and the previous grant.

Example Embodiment 21. The method of any of the previous embodiments, wherein the new grant is a dynamic grant and the previous grant is a configured grant used for Ultra-Reliable Low-Latency Communication (URLLC) type traffic.

Example Embodiment 22. The method of the previous embodiments, wherein the previous grant is prioritized over the new grant and the overlapping resources are determined to be used for the previous grant used for URLLC type traffic.

Example Embodiment 23. A method performed by a wireless device, the method comprising: determining to send control information, wherein the control information is associated with transmission resources overlapping with resources of a previous grant; prioritizing between the control information and the previous grant using priorities associated with logical channel(s) (LCH) and medium access control (MAC) control element(s) (CE) in the control information and the previous grant; and based on the prioritization, determining to use the overlapping resources for the highest priority item among the control information and the previous grant.

Example Embodiment 24. The method of any of the previous embodiments, wherein the control information includes one or more of a Scheduling Request (SR), Hybrid Automatic Repeat Request (HARQ) feedback, and/or Channel Status Information (CSI) associated with prioritized traffic and the previous grant is used for on-going uplink transmission using the uplink shared channel (UL-SCH).

Example Embodiment 25. The method of the previous embodiment, wherein the control information is prioritized over the previous grant used for on-going uplink transmission using UL-SCH and the overlapping resources are determined to be used for the control information associated with prioritized traffic.

Example Embodiment 26. The method of any of the previous embodiments, further comprising: providing user data; and forwarding the user data to a host computer via the transmission to the base station.

Example Embodiment 27. A method performed by a base station, the method comprising: signaling prioritization information to a wireless device, wherein the prioritization information indicates to the wireless device how to prioritize between a new grant or control information and a previous grant using priorities associated with logical channel(s) (LCH) and medium access control (MAC) control element(s) (CE) in the new grant or control information and the previous grant; and receiving the control information or uplink data on the new grant or receiving data on the previous grant on based on the prioritization by the wireless device.

Example Embodiment 28. The method of the previous embodiment, wherein signaling prioritization information to a wireless device comprises dynamically configuring priorities to apply to different LCHs and MAC CEs.

Example Embodiment 29. The method of any of the previous embodiments, wherein signaling prioritization information to a wireless device comprises configuring the priorities of URLLC LCHs to be higher than MAC CEs.

Example Embodiment 30. The method of any of the previous embodiments, further comprising signaling logical channel prioritization restrictions for multiplexing MAC CEs into a grant.

Example Embodiment 31. The method of any of the previous embodiments, further comprising ignoring a MAC CE in a later transmission if the MAC CE was included in the received control information or uplink data on the new grant or in the data on the previous grant.

Example Embodiment 32. The method of any of the previous embodiments, further comprising: receiving a transmission comprising a MAC CE included in the previously received control information or uplink data on the new grant or previously received data on the previous grant on based on the prioritization by the wireless device, wherein the MAC CE includes timing-related information; and determining the validity time of the MAC CE timing-related information.

Example Embodiment 33. The method of the previous embodiment, further comprising receiving an indication from the wireless device that a transmitted MAC CE was included in a previous transmission.

Example Embodiment 34. The method of the previous embodiment, wherein the indication indicates that the MAC CE was triggered and sent a number X transmission prior to the current transmission or sent a number Y slots previous to the current slot.

Example Embodiment 35. The method of any of the previous embodiments, further comprising configuring a set of priorities for a set of MAC CEs that limits the transmission of the set of MAC CEs to be transmitted on only reliability grants.

Example Embodiment 36. The method of any of the previous embodiments, further comprising: obtaining user data; and forwarding the user data to a host computer or a wireless device.

Example Embodiment 37. A wireless device, the wireless device comprising: processing circuitry configured to perform any of the steps of any of Example Embodiments 1 to 26; and power supply circuitry configured to supply power to the wireless device.

Example Embodiment 38. A base station, the base station comprising: processing circuitry configured to perform any of the steps of any of Example Embodiments 27 to 36; power supply circuitry configured to supply power to the base station.

Example Embodiment 39. A user equipment (UE), the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of Example Embodiments 1 to 26; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment 40. A computer program, the computer program comprising instructions which when executed on a computer perform any of the steps of any of Example Embodiments 1 to 26.

Example Embodiment 41. A computer program product comprising a computer program, the computer program comprising instructions which when executed on a computer perform any of the steps of any of Example Embodiments 1 to 26.

Example Embodiment 42. A non-transitory computer-readable storage medium or carrier comprising a computer program, the computer program comprising instructions which when executed on a computer perform any of the steps of any of Example Embodiments 1 to 26.

Example Embodiment 43. A computer program, the computer program comprising instructions which when executed on a computer perform any of the steps of any of Example Embodiments 27 to 36.

Example Embodiment 44. A computer program product comprising a computer program, the computer program comprising instructions which when executed on a computer perform any of the steps of any of Example Embodiments 27 to 36.

Example Embodiment 45. A non-transitory computer-readable storage medium or carrier comprising a computer program, the computer program comprising instructions which when executed on a computer perform any of the steps of any of Example Embodiments 27 to 36.

Example Embodiment 46. A communication system including a host computer comprising: processing circuitry configured to provide user data; and a communication interface configured to forward the user data to a cellular network for transmission to a user equipment (UE), wherein the cellular network comprises a base station having a radio interface and processing circuitry, the base station's processing circuitry configured to perform any of the steps of any of Example Embodiments 27 to 36.

Example Embodiment 47. The communication system of the pervious embodiment further including the base station.

Example Embodiment 48. The communication system of the previous 2 embodiments, further including the UE, wherein the UE is configured to communicate with the base station.

Example Embodiment 49. The communication system of the previous 3 embodiments, wherein: the processing circuitry of the host computer is configured to execute a host application, thereby providing the user data; and the UE comprises processing circuitry configured to execute a client application associated with the host application.

Example Embodiment 50. A method implemented in a communication system including a host computer, a base station and a user equipment (UE), the method comprising: at the host computer, providing user data; and at the host computer, initiating a transmission carrying the user data to the UE via a cellular network comprising the base station, wherein the base station performs any of the steps of any of Example Embodiments 27 to 36.

Example Embodiment 51. The method of the previous embodiment, further comprising, at the base station, transmitting the user data.

Example Embodiment 52. The method of the previous 2 embodiments, wherein the user data is provided at the host computer by executing a host application, the method further comprising, at the UE, executing a client application associated with the host application.

Example Embodiment 53. A user equipment (UE) configured to communicate with a base station, the UE comprising a radio interface and processing circuitry configured to performs the of the previous 3 embodiments.

Example Embodiment 54. A communication system including a host computer comprising: processing circuitry configured to provide user data; and a communication interface configured to forward user data to a cellular network for transmission to a user equipment (UE), wherein the UE comprises a radio interface and processing circuitry, the UE's components configured to perform any of the steps of any of Example Embodiments 1 to 26.

Example Embodiment 55. The communication system of the previous embodiment, wherein the cellular network further includes a base station configured to communicate with the UE.

Example Embodiment 56. The communication system of the previous 2 embodiments, wherein: the processing circuitry of the host computer is configured to execute a host application, thereby providing the user data; and the UE's processing circuitry is configured to execute a client application associated with the host application.

Example Embodiment 57. A method implemented in a communication system including a host computer, a base station and a user equipment (UE), the method comprising: at the host computer, providing user data; and at the host computer, initiating a transmission carrying the user data to the UE via a cellular network comprising the base station, wherein the UE performs any of the steps of any of Example Embodiments 1 to 26.

Example Embodiment 58. The method of the previous embodiment, further comprising at the UE, receiving the user data from the base station.

Example Embodiment 59. A communication system including a host computer comprising: communication interface configured to receive user data originating from a transmission from a user equipment (UE) to a base station, wherein the UE comprises a radio interface and processing circuitry, the UE's processing circuitry configured to perform any of the steps of any of Example Embodiments 1 to 26.

Example Embodiment 60. The communication system of the previous embodiment, further including the UE.

Example Embodiment 61. The communication system of the previous 2 embodiments, further including the base station, wherein the base station comprises a radio interface configured to communicate with the UE and a communication interface configured to forward to the host computer the user data carried by a transmission from the UE to the base station.

Example Embodiment 62. The communication system of the previous 3 embodiments, wherein: the processing circuitry of the host computer is configured to execute a host application; and the UE's processing circuitry is configured to execute a client application associated with the host application, thereby providing the user data.

Example Embodiment 63. The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Example Embodiment 64. A method implemented in a communication system including a host computer, a base station and a user equipment (UE), the method comprising: at the host computer, receiving user data transmitted to the base station from the UE, wherein the UE performs any of the steps of any of Example Embodiments 1 to 26.

Example Embodiment 65. The method of the previous embodiment, further comprising, at the UE, providing the user data to the base station.

Example Embodiment 66. The method of the previous 2 embodiments, further comprising: at the UE, executing a client application, thereby providing the user data to be transmitted; and at the host computer, executing a host application associated with the client application.

Example Embodiment 67. The method of the previous 3 embodiments, further comprising: at the UE, executing a client application; and at the UE, receiving input data to the client application, the input data being provided at the host computer by executing a host application associated with the client application, wherein the user data to be transmitted is provided by the client application in response to the input data.

Example Embodiment 68. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of Example Embodiments 27 to 36.

Example Embodiment 69. The communication system of the previous embodiment further including the base station.

Example Embodiment 70. The communication system of the previous 2 embodiments, further including the UE, wherein the UE is configured to communicate with the base station.

Example Embodiment 71. The communication system of the previous 3 embodiments, wherein: the processing circuitry of the host computer is configured to execute a host application; the UE is configured to execute a client application associated with the host application, thereby providing the user data to be received by the host computer.

Example Embodiment 72. A method implemented in a communication system including a host computer, a base station and a user equipment (UE), the method comprising: at the host computer, receiving, from the base station, user data originating from a transmission which the base station has received from the UE, wherein the UE performs any of the steps of any of Example Embodiments 1 to 26.

Example Embodiment 73. The method of the previous embodiment, further comprising at the base station, receiving the user data from the UE.

Example Embodiment 74. The method of the previous 2 embodiments, further comprising at the base station, initiating a transmission of the received user data to the host computer.

1. A method by a wireless device, the method comprising:
receiving a new grant for sending information, wherein the new grant is associated with at least one transmission resource overlapping with at least one resource of a previous grant;
determining a highest priority between a priority of the new grant and a priority of the previous grant, wherein:
the priority of the new grant is determined based on at least one of:
one or more logical channels, LCHs, mapped into the new grant, and
one or more medium access control-control elements, MAC CEs, mapped into the new grant,
the priority of the previous grant is determined based on at least one of:
one or more LCHs mapped into the previous grant, and
one or more MAC CEs mapped into the previous grant; and
determining to use the at least one transmission resource for the one of the new grant and the previous grant having the highest priority.

2. The method of claim 1, wherein the new grant is a configured grant or a dynamic grant and the previous grant is a configured grant or a dynamic grant.

3. The method of claim 1, wherein:
the information associated with the new grant comprises control information associated with prioritized traffic,
the previous grant is used for an on-going uplink transmission using the uplink shared channel, UL-SCH, and
the at least one transmission resource is determined to be used for sending the prioritized traffic and control information associated with the new grant.

4. The method of claim 1, wherein:
the previous grant is for sending control information associated with prioritized traffic, and
the at least one transmission resource is determined to be used for sending the prioritized traffic and the control information associated with previous grant.

5. The method of claim 1, wherein:
the new grant is a dynamic grant and the previous grant is a configured grant used for Ultra-Reliable Low-Latency Communication, URLLC, type traffic,
the highest priority of the new grant and the previous grant is the previous grant, and
the overlapping resources are determined to be used for the URLLC type traffic and control information associated with the URLLC type traffic.

6. The method of claim 1, wherein a physical data unit, PDU, has been constructed for the previous grant before receiving the new grant and before determining whether to send the information associated with the previous grant.

7. The method of claim 1, wherein a physical data unit, PDU, has not yet been constructed for the previous grant before receiving the new grant.

8. The method of claim 1, wherein the prioritization of the LCHs and MAC CEs is predetermined based on at least one of a rule and a standard.

9. The method of claim 1, wherein:
the priority of the new grant comprises a highest priority of the one or more LCHs and one or more MAC CEs mapped into the new grant; and
the priority of the previous grant comprises a highest priority of the one or more LCHs and one or more MAC CEs mapped into the previous grant.

10. The method of claim 9, wherein the highest priority of the one or more LCHs and one or more MAC CEs mapped into the new grant or the previous grant is determined as follows with highest to lowest priorities listed in descending order:
Cell Radio Network Temporary Identifier, C-RNTI, MAC CE or data from uplink common control channel, UL-CCCH;
Configured Grant Confirmation MAC CE;
MAC CE for Buffer Status Report, BSR, with exception of BSR included for padding;
Single Entry Power Headroom Report, PHR, MAC CE or Multiple Entry PHR MAC CE;
data from any Logical Channel, except data from the UL-CCCH;
MAC CE for Recommended bit rate query; and
MAC CE for BSR included for padding.

11. The method of claim 9, wherein the highest priority of the one or more LCHs and one or more MAC CEs mapped into the new grant or the previous grant is determined based on signalling received from a network node 160.

12. The method of claim 1, wherein, when determining the priority of the new grant and the priority of the previous grant, any grant for which only one or more MAC CEs are available for transmission will be considered as having lower priority than any grant for which traffic and any number of MAC CEs are available for transmission.

13.-17. (canceled)

18. A method by a network node, the method comprising:
signalling prioritization information to a wireless device, wherein the prioritization information indicates a highest priority between a priority of a new grant and a priority of a previous grant, the new grant and the previous grant being associated with at least one overlapping transmission resource, wherein:
the priority of the new grant is based on at least one of:
one or more logical channels, LCHs, mapped into the new grant, and
one or more medium access control-control elements, MAC CEs, mapped into the new grant,
the priority of the previous grant is based on at least one of:
one or more LCHs mapped into the previous grant, and
one or more MAC CEs mapped into the previous grant,
receiving, in the at least one overlapping transmission resource, a transmission associated with the highest priority of the new grant or the previous grant based on the prioritization information signalled to the wireless device.

19.-30. (canceled)

31. A network node comprising processing circuitry configured to perform the method of claim 18.

32. A method by a wireless device, the method comprising:
determining that at least one transmission resource associated with a scheduling request overlaps with at least one resource of a previous grant;
determining a highest priority between a priority of the scheduling request and a priority of the previous grant, wherein:
the priority of the scheduling request is determined based on one or more logical channels, LCHs, triggering the scheduling request, and
the priority of the previous grant is determined based on at least one of:
one or more LCHs mapped into the previous grant, and
one or more MAC CEs mapped into the previous grant; and
determining to use the at least one transmission resource for the one of the scheduling request and the previous grant having the highest priority.

33. The method of claim 32, wherein the highest priority between the priority of the scheduling request and the priority of the previous grant is determined based on a prioritization handling rule.

34. The method of claim 33, further comprising receiving the prioritization handling rule from a network node.

35. The method of claim 32, wherein:
the scheduling request is associated with high-priority information,
the previous grant is associated with low-priority information,
the scheduling request is determined to be the highest priority, and
determining to use the at least one transmission resource for the one of the scheduling request and the previous grant comprises determining to use the at least one transmission resource for the scheduling request.

36. The method of claim 32, wherein:
the scheduling request is associated with low-priority information,
the previous grant is associated with high-priority information,
the previous grant is determined to be the highest priority, and
determining to use the at least one transmission resource for the one of the scheduling request and the previous grant comprises determining to use the at least one transmission resource for the previous grant.

37. A wireless device comprising processing circuitry configured to perform the method of claim 32.

38. A method performed by a network node the method comprising:
signalling prioritization information to a wireless device, wherein the prioritization information indicates a highest priority between a priority of a scheduling request and a priority of a previous grant, the scheduling request and the previous grant being associated with at least one overlapping transmission resource, wherein:
the priority of the scheduling request is based on one or more logical channels, LCHs, triggering the scheduling request, and
the priority of the previous grant is based on at least one of:
one or more LCHs mapped into the previous grant, and
one or more MAC CEs mapped into the previous grant; and
receiving, in the at least one overlapping transmission resource, a transmission associated with the highest priority of the scheduling request or the previous grant based on the prioritization information signalled to the wireless device.

39.-41. (canceled)

42. A network node comprising processing circuitry configured to perform the method of claim 38.
